(19) United States
(12) Patent Application Publication
(10) Pub. No.: US 2018/0029088 A1
(43) Pub. Date: Feb. 1, 2018

(54) METHOD AND APPARATUS FOR FILM TREATMENT

(71) Applicant: Geo-Tech Polymers, LLC, Westerville, OH (US)

(72) Inventors: Stephen Craig Tackett, Greenup, KY (US); Ronald Lee Whaley, Monmouth, IL (US); Dennis Ray Tackett, Washington Court House, OH (US); Sreevalli Bokka, Chillicothe, OH (US); Travis Scott Nickel, Raceland, KY (US)

(21) Appl. No.: 15/659,935

(22) Filed: Jul. 26, 2017

Related U.S. Application Data
(60) Provisional application No. 62/366,915, filed on Jul. 26, 2016.

(51) Int. Cl. B08B 3/04; B08B 3/12; C08J 11/06; B02C 18/00; C08J 3/12; C08J 11/04; B08B 3/10; B08B 7/04

(52) U.S. Cl. CPC B08B 3/041; B08B 3/10; B08B 3/123; B08B 7/04; B02C 18/00; C08J 3/12; C08J 11/04; C08J 11/06

(57) ABSTRACT

A coated polymeric film is comminuted, and is advanced between successive processing stations in a coating removal system in a stream of conveyance fluid driven through a conduit reaching between the successive processing stations.

### RELATED APPLICATIONS

This application claims priority of provisional U.S. patent application 62/366,915, filed Jul. 26, 2016, which is incorporated by reference.

### TECHNICAL FIELD

This technology relates to the removal of undesirable coatings from polymeric films in preparation for recycling.

### BACKGROUND

Polymeric films to be recycled may have coatings that are undesirable in the recycled material. For example, such coatings may include inks, labels, adhesives, metallic films, and the like, as used in packaging or manufacture of personal care products such as diapers and diaper packaging. It may be desirable to process the polymeric films to remove the undesirable coatings prior to further uses of the films, such as recycled feed stocks for remanufactured plastics.

### SUMMARY

Each of the following summary paragraphs describes an example of how the invention may be implemented as a combination of structural or method elements disclosed by the detailed description that follows. Any one or more of the elements of each summary paragraph may be utilized with any or more of the distinct elements of another.

In a given example, a method forms comminuted material by comminuting a coated polymeric film. The method advances the comminuted material between successive processing stations in a coating removal system. This is accomplished by conveying the comminuted material in a stream of conveyance fluid driven through a conduit reaching between the successive processing stations.

The method may comprise blowing the comminuted material through a conduit, discharging the comminuted material from the conduit into a milling device containing an aqueous solution for removing coating material from the comminuted material, and mixing the comminuted material with the aqueous solution in the milling device.

Additional processing may comprise pumping a mixture of the comminuted material and the aqueous solution through a conduit from the milling device to a straining device, pumping the mixture further through a conduit from the straining device to a washing device, and pumping a mixture of water and comminuted material from the washing device to a dryer.

An apparatus may thus comprise means for forming comminuted material by comminuting coated polymeric film, and means for advancing the comminuted material between successive processing stations in a coating removal system by conveying the comminuted material in a stream of conveyance fluid reaching between the successive processing stations.

In a given example, the apparatus includes a milling device containing an aqueous solution for removing coating material from the comminuted material. A conduit has an inlet configured to receive the comminuted material, and has an outlet configured to discharge the comminuted material into the milling device. A blower is coupled to the conduit to provide a stream of conveyance air for conveying the comminuted material through the conduit.

The apparatus may further include means for straining a mixture of the comminuted material and the aqueous solution, and means for pumping the mixture from the milling device to the straining means.

Additional elements may include means for washing and rinsing the aqueous solution from the mixture, means for pumping the mixture from the straining means to the washing means, and means for pumping a mixture of water and comminuted material from the washing means to a dryer.

### BRIEF DESCRIPTION OF THE DRAWINGS

FIG. 1 is a schematic view of components of a system for the treatment of coated plastic film material.

FIG. 2 is a schematic showing additional components of the system of FIG. 1.

FIG. 3 also is a schematic showing additional components of the system of FIG. 1.

FIG. 4 is a detailed schematic view of a component shown in FIG. 1.

### DETAILED DESCRIPTION

The system illustrated in the drawings can be operated as recited in the method claims, and has components that are examples of the elements recited in the apparatus claims. The illustrated system thus includes examples of how a person of ordinary skill in the art can make and use the claimed invention. It is described here to meet the enablement and best mode requirements of the patent statute without imposing limitations that are not recited in the claims.

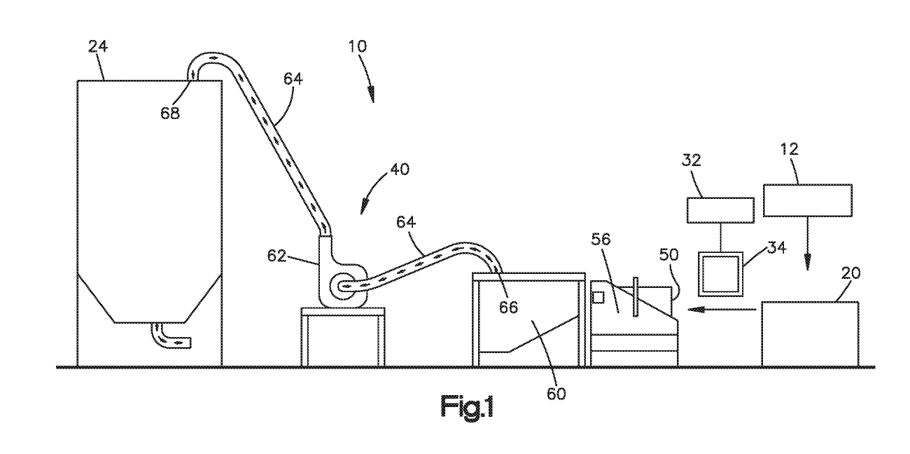

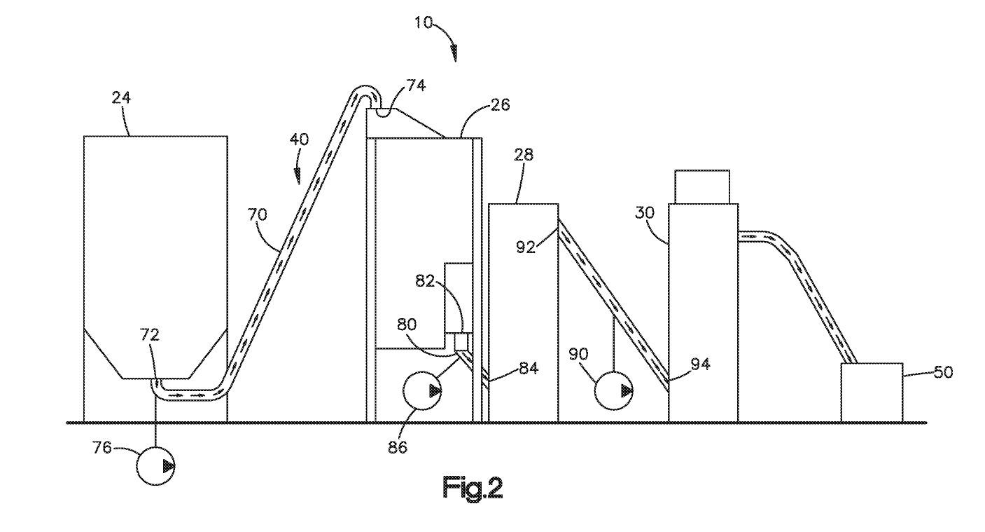

As shown in FIGS. 1-3, a system 10 is provided for the treatment of coated polymeric film material 12. The system 10 has components arranged as successive processing stations at which the film material 12 is treated. These include a comminuting device 20 at one end of the system 10, as shown in FIG. 1, and an extruder 22 at the opposite end of the system 10, as shown in FIG. 3. Intermediate processing stations are defined by a mill tank 24 (FIGS. 1 and 2), as well as a dump tank 26, a washer 28, and a dryer 30 (FIG. 2). The components 20-30 may be interconnected to operate under the control of a PLC 32 with a monitor 34.

A conveyance subsystem 40 reaches through the system 10 to advance the film material 12 between successive processing stations, also under control of the PLC 32. As further shown in the drawings, the conveyance subsystem 40 includes conduits and pumps that convey the film material 12 between successive processing stations in streams of conveyance fluid.

The coated polymeric film material 12 is obtained from a manufacturer or other source of recyclable material, and is typically provided in bales of separate pieces, such as bags, or in rolls of continuous pieces. The film material 12 may also be provided as a collection of separate pieces of scrap material having a range of differing sizes and shapes. In each case, the film material 12 is inherently flexible and tends to deform, such as by crimping or tangling, more easily than relatively thick-walled plastic pieces such as bottles and the like. Accordingly, the film material 12 is shredded, granulated, or otherwise comminuted in the comminuting device 20 before being advanced further through the system 10. This reduces the sizes of separate pieces of the film material 12, and also renders them more uniformly sized and shaped, so that the comminuted film material 12 is flowable through the system without becoming tangled or jammed.

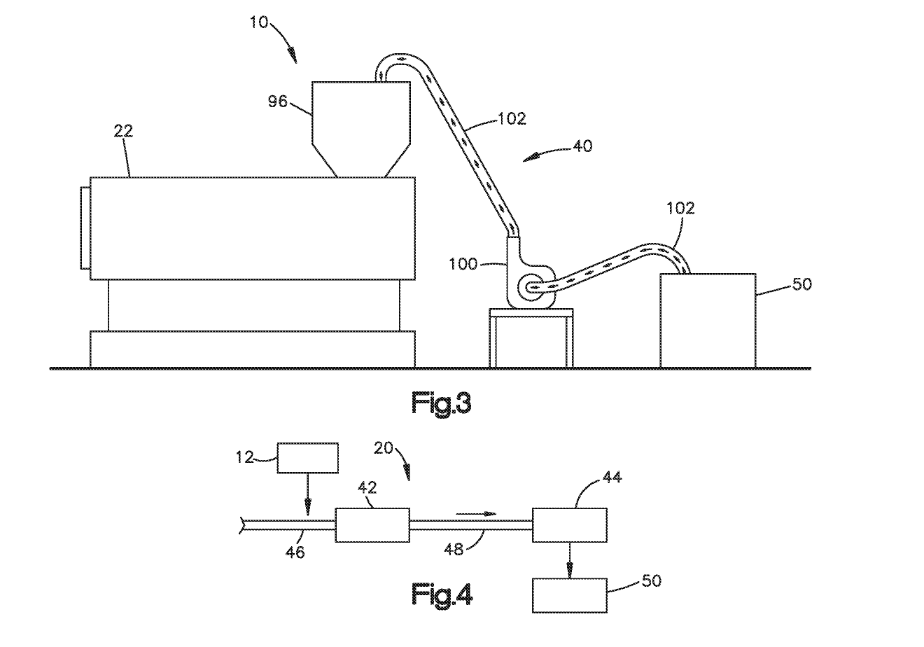

As shown in greater detail FIG. 4, the comminuting device 20 in the given example includes both a shredder 42 and a granulator 44. The film material 12 is placed on a conveyor 46 that takes the film material 12 to the shredder 42, or the film material may alternatively be placed directly into the shredder 42. The shredder 42 cuts the film material 12 into smaller pieces, and dumps the cut film material 12 onto another conveyor 48 that takes it to the granulator 44.

Once the cut film material is in the granulator 44, it is size-reduced to a specified size based on the material and application. Different size screens in the granulator 44 allow the cut film material 12 to be reduced to different sizes. The screens sort the granulated film material 12 and allow it to fall into receptacles 50 such as boxes or bags, or into a pump, once it is reduced to the size needed.

Referring again to FIG. 1, a box 50 of the granulated film material 12 is loaded into a box dumper 56, which dumps the granulated film material 12 into a receptacle 60. The conveyance subsystem 40 includes a light material feed pump 62 in a conduit 64. The conduit 64 has an inlet 66 at the receptacle 60, and has an outlet 68 at the mill tank 24. The pump 62 drives a stream of conveyance air that blows the granulated film material 12 through the conduit 64 from the receptacle 60 into the mill tank 24.

The mill tank 24 contains an aqueous solution for removing coating material from the granulated film material 12. The aqueous solution may have any suitable composition known in the art, and may alternatively have a composition as described in any one or more of the following U.S. Patent Applications, each of which is incorporated by reference:

U.S. patent application Ser. No. 14/830,529, filed Aug. 19, 2015.

U.S. patent application Ser. No. 14/830,639, filed Aug. 19, 2015.

U.S. patent application Ser. No. 14/830,626, filed Aug. 19, 2015.

U.S. patent application Ser. No. 14/830,614, filed Aug. 19, 2015.

U.S. patent application Ser. No. 15/049,105, filed Feb. 21, 2016.

U.S. patent application Ser. No. 15/049,106, filed Feb. 21, 2016.

U.S. patent application Ser. No. 15/049,107, filed Feb. 21, 2016.

The aqueous solution in the mill tank 24 is preferably heated before the granulated film material 12 is inserted. The mill tank 24 has an agitator, such as a shaft with three blades, that stir and mix the contents. This provides heat, friction, and chemicals that together remove the coating material from the granulated film material 12.

Samples of the granulated film material 12 are taken out of the mill tank 24 periodically to perform a contaminant count, to determine parts per million of coating on the plastic, until the material passes inspection. Usually the initial sample is weighed, then the coated pieces are pulled out and reweighed. Then a calculation using both weights is performed to determine the parts per million that are still coated.

As shown in FIG. 2, the conveyance subsystem 40 in the illustrated example further includes a conduit 70 with an inlet 72 at the mill tank 24 and an outlet 74 at the dump tank 26. Once the granulated film material 12 passes inspection at the mill tank 24, it is conveyed through the conduit 70 from the mill tank 24 to the dump tank 26. A pump 76 uses the aqueous fluid in the mill tank 24 as the conveyance fluid for this movement of the granulated film material 12.

The dump tank 26 strains the aqueous solution from the granulated film material 12. Specifically, the granulated film material 12 goes across a screen where the water and chemicals drain into a separate section of the dump tank 26. Once the material goes across the screen it falls into a larger section of the dump tank 26.

There are a few ways to feed the material through the dump tank 26 into the next phase of the process. One way is to use an auger to push the material through the bottom of the tank. Also a rotary valve can be used with the auger system to help push material through the tank. If the auger is used, water is sprayed onto the auger and material to keep the plastic wet, to allow the auger to push the material. Another way to move the material through the dump tank 26 is to remove the rotary valve at the bottom of the tank, and have the operator use a manual slide to regulate the flow rate of the material.

Once the granulated film material 12 is pumped out of the dump tank 26, it goes into the washer 28, which washes all the chemicals off the plastic and rinses it with water. In the illustrated example, the conveyance subsystem 40 includes a conduit 80 having an inlet 82 in the dump tank 26, an outlet 84 at the washer 28, and a pump 86 for driving the granulated film material 12 through the conduit 80.

Next, a pump 90 drives the granulated film material 12 through a conduit 90 having an inlet 92 at the washer 28 and an outlet 94 at the dryer 30. Finally, the cleaned and dried granulated film material is pushed out of the dryer 30 and into receptacles 50 for transportation to the extruder 22.

The extrusion phase is started by pumping the cleaned, dried granulated film material 12 out of the receptacles 50 and into a hopper 96 at the extruder 22. In the illustrated example, this is accomplished by a pump 100 in a conduit 102 in substantially the same manner that the coated granulated film material 12 is delivered to the mill tank 24 by the pump 62 and conduit 64 described above with reference to FIG. 1. Once the material is loaded into the hopper 96, it is fed into the extruder 22. The material is extruded using the appropriate speeds and temperature for the material. As the material is extruded, it is made into small round pellets using an underwater pelletizer. The pellets are then pumped through pipes into a drying system and then into boxes, ready for inspection.

This written description sets for the best mode of carrying out the invention, and describes the invention so as to enable a person of ordinary skill in the art to make and use the invention, by presenting examples of the elements recited in the claims. The detailed descriptions of those elements do not impose limitations that are not recited in the claims, either literally or under the doctrine of equivalents.

What is claimed is:

1. A method comprising:
forming comminuted material by comminuting a coated polymeric film; and
advancing the comminuted material between successive processing stations in a coating removal system by conveying the comminuted material in a stream of conveyance fluid driven through a conduit reaching between the successive processing stations.

2. A method as defined in claim 1 wherein the stream of conveyance fluid comprises a stream of air.

3. A method as defined in claim 1 wherein the stream of conveyance fluid comprises an aqueous solution for removing coating material from the comminuted material.

4. A method as defined in claim 1, wherein the comminuting comprises shredding.

5. A method as defined in claim 1, wherein the comminuting comprises granulating.

6. A method comprising:
forming comminuted material by comminuting a coated polymeric film;
blowing the comminuted material through a conduit;
discharging the comminuted material from the conduit into a milling device containing an aqueous solution for removing coating material from the comminuted material; and
mixing the comminuted material with the aqueous solution in the milling device.

7. A method as defined in claim 6, further comprising pumping a mixture of the comminuted material and the aqueous solution through a conduit from the milling device to a straining device, and straining the mixture in the straining device.

8. A method as defined in claim 7, wherein the mixture is moved through the straining device by an auger.

9. A method as defined in claim 7, further comprising pumping the mixture through a conduit from the straining device to a washing device, and rinsing the aqueous solution from the mixture with water in the washing device.

10. A method as defined in claim 9, further comprising pumping a mixture of water and comminuted material from the washing device to a dryer, and drying the comminuted material in the dryer.

11. A method as defined in claim 10, further comprising feeding dried comminuted material from the dryer to an extruder, and extruding the dried comminuted material in a pelletized form.

12. A method as defined in claim 6, wherein the comminuting comprises shredding.

13. A method as defined in claim 6, wherein the comminuting comprises granulating.

14. A method as defined in claim 6, further comprising heating the aqueous solution.

15. An apparatus comprising:
means for forming comminuted material by comminuting a coated polymeric film; and
means for advancing the comminuted material between successive processing stations in a coating removal system by conveying the comminuted material in a stream of conveyance fluid reaching between the successive processing stations.

16. An apparatus as defined in claim 15, wherein the stream of conveyance fluid comprises a stream of air.

17. An apparatus as defined in claim 15, wherein the streams of conveyance fluid comprises an aqueous solution for removing coating material from the comminuted material.

18. An apparatus as defined in claim 15, wherein the means for forming comprises means for shredding.

19. An apparatus as defined in claim 15, wherein the means for forming comprises means for granulating.

20. An apparatus comprising:
means for forming comminuted material by granulating a coated polymeric film;
a milling device containing an aqueous solution for removing coating material from the comminuted material;
a conduit having an inlet configured to receive the comminuted material and an outlet configured to discharge the comminuted material into the milling device; and
a blower coupled to the conduit to provide a stream of conveyance air for conveying the comminuted material through the conduit.

21. An apparatus as defined in claim 20, further comprising means for straining a mixture of the comminuted material and the aqueous solution, and means for pumping the mixture from the milling device to the straining means.

22. An apparatus as defined in claim 20, wherein the straining means includes an auger operative to move the mixture.

23. An apparatus as defined in claim 20, further comprising means for washing and rinsing the aqueous solution from the mixture, and means for pumping the mixture from the straining means to the washing means.

24. An apparatus as defined in claim 20, further comprising a dryer and means for pumping a mixture of water and comminuted material from the washing means to the dryer.

25. An apparatus as defined in claim 20, further comprising means for extruding the comminuted material in a pelletized form.
